(19) United States
(12) Patent Application Publication
(10) Pub. No.: US 2015/0186816 A1
(43) Pub. Date: Jul. 2, 2015

(54) SYSTEM AND METHOD FOR ASSESSING SUSTAINABILITY OF OVERSEAS GAS FIELD

(71) Applicant: Industry-Academic Cooperation Foundation, Yonsei University, Seoul (KR)

(72) Inventors: Seung Heon Han, Gwacheon-si (KR); Woo Sik Jang, Seoul (KR); Heedae Park, Seoul (KR); Seokjin Choi, Seoul (KR)

(73) Assignee: Industry-Academic Cooperation Foundation, Yonsei University, Seoul (KR)

(21) Appl. No.: 14/205,588

(22) Filed: Mar. 12, 2014

(30) Foreign Application Priority Data
Dec. 30, 2013 (KR) 10-2013-0167116

(51) Int. Cl. G06Q 10/06; G06Q 50/06

(52) U.S. Cl. CPC G06Q 10/0635; G06Q 50/06

(57) ABSTRACT

A system for assessing sustainability of an overseas gas field development project includes a gas field factor analysis section configured to calculate assessment values for components of gas, expected reserves, ratio of NGL (natural gas liquid)/condensate, and infrastructure accessibility; a financial factor analysis section configured to calculate assessment values for independent oil company (IOC) share ratio, past collaboration experience, business execution experience, and favorable investment ratio; an organization factor analysis section configured to calculate assessment values for development business execution experience, securement level of expertise, the owner's risk, and securement level of dealer; and a sustainability index calculation section configured to calculate a sustainability index, based on the assessment values.

### CROSS-REFERENCES TO RELATED APPLICATIONS

The present application claims priority under 35 U.S.C 119(a) to Korean Application No. 10-2013-0167116, filed on 30 Dec. 2013, in the Korean Intellectual Property Office, which is incorporated herein by reference in its entirety set forth in full.

### TECHNICAL FIELD

Exemplary embodiments of the present invention relate to assessment of business feasibility of a development project, and more particularly, to a technology of assessing sustainability of an overseas gas field development project.

### BACKGROUND OF THE INVENTION

Recently, the demand for natural gas has increased since the emission of a carbon dioxide has half the amount compared to coal and the emissions of a nitrogen oxide and a sulfur oxide are also smaller when compared with natural gas used as a fuel for power generation or a fuel for heating. While the reserve production ratio (R/P) of natural gas was expected in the past to be about 70 years, the reserve production ratio is abruptly increasing nowadays due to recent development boom of shale gas. Therefore, it is highly likely that the utilization of natural gas will be increased in the future when compared to petroleum which has the reserve production ratio of about 40 years.

Global natural gas markets are generally divided into North America, Europe and East Asia. Among these markets, even though East Asia has emerged as the largest natural gas consuming region, the price of natural gas (LNG) from Indonesia that is regarded as the standard market price is about 2 to 4 times higher than HH (Henry Hub) and the US market standard or NPB (National Balancing Point) and the European market standard. In North America or Europe, because gas is stably supplied in large quantities through gas pipelines, the price of gas is low. However, in East Asia or Africa, because gas is supplied through shipping, the price of gas is high although shipping has become flexible to a certain extend.

Specifically, Korea's average import price of LNG is 14.72 dollars per MBTU (1000 British Thermal Units), which is higher compared to the world's average of 8.95 dollars and the US average of 1.5 dollars. This may result due to focusing on only stable import of LNG and neglecting the development of overseas gas fields.

Enterprises that participate in overseas gas field development projects process the projects through business selection stage, business feasibility studying stage, Pre-FEED (preliminary front end engineering design) and FEED (front end engineering design) stage, engineering-procurement-construction (EPC) stage, and operating stage.

Since an overseas gas field development project continuously requires a large amount of capital before entering into stable operation stage without substantial profit, business is likely to fail due to complications between participants or uncertainty of financing.

Although a new enterprise who wants to participate in the project performs various assessments in the course of acquiring a share, the new enterprise estimates the value of the share based on financial assessment performed in consideration of expected reserves or possibility of price fluctuation.

However, such estimation of the value is based on the assumption that the business will be stably operated, and thus, it is actually difficult to consider the risk or possibility of fluctuation in the course of progressing or operating the project.

### SUMMARY

Embodiments of the present invention are directed to a system and a method for assessing sustainability of an overseas gas field development project.

Embodiments of the present invention are directed to a system and a method for assessing sustainability of an overseas gas field development project, at the initial stage of the project.

Embodiments of the present invention are directed to a system and a method for assessing sustainability of an overseas gas field development project, based on the technical characteristics of a gas field, the stability of a business participant and the stability of business, by deviating from a financial assessment viewpoint.

Problems to be solved by the present invention are not limited to the above-mentioned ones, and other problems which are not mentioned above may be clearly understood from the following descriptions by those skilled in the art.

In accordance with an aspect of the present invention, a system for assessing sustainability of an overseas gas field development project may include: a gas field factor analysis section configured to calculate assessment values respectively quantified for assessment items including components of gas, expected reserves, ratio of NGL (natural gas liquid)/condensate, and infrastructure accessibility; financial factor analysis section configured to calculate assessment values respectively quantified for assessment items including an independent oil company (IOC) share ratio, past collaboration experience, business execution experience, and a favorable investment ratio; an organization factor analysis section configured to calculate assessment values respectively quantified for assessment items including development business execution experience, securement level of expertise, owner's risk, and securement level of dealer; and a sustainability index calculation section configured to calculate a sustainability index, based on the assessment values for the assessment items including the components of gas, the expected reserves, the ratio of NGL/condensate and the infrastructure accessibility, which are calculated by the gas field factor analysis section, the assessment values for the assessment items including the IOC share ratio, the past collaboration experience, the business execution experience and the favorable investment ratio, which are calculated by the financial factor analysis section, and the assessment values for the assessment items including the development business execution experience, the securement level of expertise, the owner's risk and the securement level of dealer, which are calculated by the organization factor analysis section.

In an embodiment, the assessment item of components of gas may be an assessment item that is assessed in association with value of product produced by RFG (raw feed gas) extracted from a gas field, the assessment item of expected reserves may be an assessment item that is assessed in association with reserves which are expected through analysis of corresponding mining area, the assessment item of ratio of NGL/condensate may be an assessment item that is assessed in association with a ratio of impurities and additional profitable materials, and the assessment item of infrastructure accessibility may be an assessment item that is assessed in association with accessibility between upstream fields and downstream fields.

In an embodiment, the assessment item of IOC share ratio may be an assessment item that is assessed in association with a ratio of share of IOC enterprises in entire share, the assessment item of past collaboration experience may be an assessment item that is assessed in association with reputation of past business and non-business relations between participants, the assessment item of business execution experience may be an assessment item that is assessed in association with business competences of a leading enterprise of a gas field development project and a government of the owner's country, and the assessment item of favorable investment ratio may be an assessment item that is assessed in association with a ratio of favorable investment in structure of financial investments.

In an embodiment, the assessment item of development business execution experience may be an assessment item that is assessed in association with industrial understanding of an enterprise for gas field business, the assessment item of securement level of expertise may be an assessment item that is assessed in association with technical understanding of gas field business, the assessment item of the owner's risk may be an assessment item that is assessed in association with reliability of the owner, and the assessment item of securement level of dealer may be an assessment item that is assessed in association with anticipation of stable profits.

In an embodiment, the sustainability index may be calculated by performing TOPSIS (technique for order of preference by similarity to ideal solution) analysis or fuzzy TOPSIS analysis, based on the assessment values respectively quantified for the assessment items including components of gas, expected reserves, ratio of NGL/condensate, infrastructure accessibility, IOC share ratio, past collaboration experience, business execution experience, favorable investment ratio, development business execution experience, securement level of expertise, owner's risk, and securement level of dealer.

In an embodiment, the sustainability index may be calculated from assessment values that constitute an optimal assessment result, the optimal assessment result being extracted through TOPSIS analysis of assessment results obtained by professionals who assess the respective assessment items.

In an embodiment, the sustainability index may be calculated from assessment values that constitute an optimal assessment result, the optimal assessment result being extracted through fuzzy TOPSIS analysis of fuzzy assessment results which are converted from assessment results obtained by professionals who assess the respective assessment items.

In an embodiment, the sustainability index calculation section may operate to calculate a gas field characteristic index based on the assessment items including components of gas, expected reserves, ratio of NGL/condensate and infrastructure accessibility, calculate a participant stability index based on the assessment items including IOC share ratio, past collaboration experience, business execution experience and favorable investment ratio, calculate a business stability index based on the assessment items including development business execution experience, securement level of expertise, owner's risk and securement level of dealer, among the extracted optimal assessment results, and calculate the sustainability index based on the gas field characteristic index, the participant stability index and the business stability index.

In an embodiment, the sustainability index may be calculated, based on any one selected from summation, weighted summation, arithmetic averaging and weighted averaging of the gas field characteristic index, the participant stability index and the business stability index.

In accordance with another aspect of the present invention, a method for assessing sustainability of an overseas gas field development project, using an overseas gas field development project sustainability assessing system, which includes a gas field factor analysis section, a financial factor analysis section, an organization factor analysis section and a sustainability index calculation section, may include: calculating, by the gas field factor analysis section, assessment values respectively quantified for assessment items including components of gas, expected reserves, ratio of NGL/condensate, and infrastructure accessibility; calculating, by the financial factor analysis section, assessment values respectively quantified for assessment items including IOC share ratio, past collaboration experience, business execution experience, and favorable investment ratio; calculating, by the organization factor analysis section, assessment values respectively quantified for assessment items including development business execution experience, securement level of expertise, owner's risk, and securement level of dealer; and calculating, by the sustainability index calculation section, a sustainability index, based on the assessment values for the assessment items including components of gas, expected reserves, ratio of NGL/condensate and infrastructure accessibility, which are calculated by the gas field factor analysis section, the assessment values for the assessment items including IOC share ratio, past collaboration experience, business execution experience and favorable investment ratio, which are calculated by the financial factor analysis section, and the assessment values for the assessment items including development business execution experience, securement level of expertise, owner's risk and securement level of dealer, which are calculated by the organization factor analysis section.

In an embodiment, the assessment item of components of gas may be an assessment item that is assessed in association with value of product produced by RFG (raw feed gas) extracted from a gas field, the assessment item of expected reserves may be an assessment item that is assessed in association with reserves which are expected through analysis of a corresponding mining area, the assessment item of ratio of NGL/condensate may be an assessment item that is assessed in association with ratio of impurities and additional profitable materials, and the assessment item of infrastructure accessibility may be an assessment item that is assessed in association with accessibility between upstream fields and downstream fields.

In an embodiment, the assessment item of IOC share ratio may be an assessment item that is assessed in association with ratio of shares of IOC enterprises in entire share, the assessment item of past collaboration experience may be an assessment item that is assessed in association with reputation of past business and non-business relations between participants, the assessment item of business execution experience may be an assessment item that is assessed in association with business competences of a leading enterprise of a gas field development project and a government of the owner's country, and the assessment item of favorable investment ratio may be an assessment item that is assessed in association with ratio of favorable investment in spectrum of financial investments.

In an embodiment, the assessment item of development business execution experience may be an assessment item that is assessed in association with industrial understanding of an enterprise for gas field business, the assessment item of securement level of expertise may be an assessment item that is assessed in association with technical understanding of gas field business, the assessment item of the owner's risk may be an assessment item that is assessed in association with reliability of the owner, and the assessment item of securement level of dealer may be an assessment item that is assessed in association with anticipation of stable profits.

In an embodiment, the sustainability index may be calculated by performing TOPSIS (technique for order of preference by similarity to ideal solution) analysis or fuzzy TOPSIS analysis, based on the assessment values respectively quantified for the assessment items including components of gas, expected reserves, ratio of NGL/condensate, infrastructure accessibility, IOC share ratio, past collaboration experience, business execution experience, favorable investment ratio, development business execution experience, securement level of expertise, the owner's risk, and securement level of dealer.

In an embodiment, the sustainability index may be calculated from assessment values that constitute an optimal assessment result, the optimal assessment result being extracted through TOPSIS analysis of assessment results obtained by professionals who assess the respective assessment items.

In an embodiment, the sustainability index may be calculated from assessment values that constitute an optimal assessment result, the optimal assessment result being extracted through fuzzy TOPSIS analysis of fuzzy assessment results which are converted from assessment results obtained by professionals who assess the respective assessment items.

In an embodiment, the calculating of the sustainability index may include calculating a gas field characteristic index based on the assessment items including components of gas, expected reserves, ratio of NGL/condensate and infrastructure accessibility; calculating a participant stability index based on the assessment items including an IOC share ratio, past collaboration experience, business execution experience and favorable investment ratio; calculating a business stability index based on the assessment items including development business execution experience, securement level of expertise, the owner's risk and securement level of dealer, among extracted optimal assessment results; and calculating the sustainability index based on the gas field characteristic index, the participant stability index and the business stability index.

In an embodiment, the sustainability index may be calculated, based on any one selected from summation, weighted summation, arithmetic averaging and weighted averaging of the gas field characteristic index, the participant stability index and the business stability index.

According to the system and the method for assessing sustainability of an overseas gas field development project in accordance with the embodiments of the present invention, it is possible to assess the value of business at an initial stage of the project.

According to the system and method for assessing sustainability of an overseas gas field development project in accordance with the embodiments of the present invention, it is possible to assess the value of business, based on the technical characteristic of a gas field, the stability of a business participant and the stability of business, so as to get out of simple financial assessment viewpoint.

Effects of the present invention are not limited to the above-mentioned ones, and other effects which are not mentioned above may be clearly understood from the following descriptions by those skilled in the art.

### BRIEF DESCRIPTION OF THE DRAWINGS

The above and other aspects, features and other advantages will be more clearly understood from the following detailed description taken in conjunction with the accompanying drawings, in which:

FIG. 1 is a conceptual diagram illustrating a system for assessing sustainability of an overseas gas field development project in accordance with an embodiment of the present invention;

FIG. 2 is a table exemplarily showing a result of assessing an overseas gas field development project based on an actually performed example, in the system for assessing sustainability of an overseas gas field development project in accordance with the embodiment of the present invention; and

FIG. 3 is a flow chart illustrating a method for assessing sustainability of an overseas gas field development project in accordance with an embodiment of the present invention.

### DESCRIPTION OF SPECIFIC EMBODIMENTS

In the embodiments of the present invention disclosed herein, specific structural and functional descriptions are given for an illustration purpose only to describe the embodiments of the present invention. The embodiments of the present invention may be implemented in various forms and should not be construed as limited to those set forth herein.

Hereinafter, exemplary embodiments of the present invention will be described in more detail with reference to the accompanying drawings. Hereinafter, the same reference numerals will be used to describe the same components throughout the accompanying drawings, and repeated descriptions for the same components will be omitted.

FIG. 1 is a conceptual diagram illustrating a system for assessing sustainability of an overseas gas field development project in accordance with an embodiment of the present invention.

The system for assessing sustainability of an overseas gas field development project in accordance with the embodiment of the present invention is to assess value, based on the concept of sustainability in a gas field development project.

Trading of Oil fields and gas fields all over the world amounts to 1,794 hundred million dollars with 294 cases in 2010. In particular, 57% of the total volume was traded in North America. In the United States, which is regarded stable in politics and economy, the open market and the exchange are developed, and thus, the United States is recognized as a market in which most of risks associated with the execution of business are identified.

As such, in assessing the value of a gas field, it is regarded important to assess a business participant in addition to considering a financial viewpoint.

Meanwhile, the ecosystem of the gas industry for supplying gas from a gas field to dealers is divided into an upstream field which is associated with developing, drilling and operating a gas field, a mid-stream field which is associated with transportation and treatment facilities, and a downstream field which is associated with refinement and sale. The downstream field may often cover the mid-stream field.

Although gas field business belongs to the upstream field, enterprises of the downstream field, which take charge of treatment, storage, transportation and sale of gas, are likely to be influenced in terms of applied technology, throughput, quality and financial feasibility, depending on the components and characteristics of a gas field.

Notwithstanding, in the conventional approaches for assessing the value of a gas field, the quality of gas produced from a gas field under operation is regarded as main factor, and it is difficult to consider fluctuation of a gas field under planning, even of plant construction, at an initial stage of a gas field development project.

Therefore, the system for assessing sustainability of an overseas gas field development project in accordance with the embodiment of the present invention assesses the value of gas field business, based on sustainability, or possibility of solving uncertainty, technical difficulty and financial problem, at an initial stage, continuously progressing the business and making profit by stably supplying and selling gas of expected quality over a long term.

The system for assessing sustainability of an overseas gas field development project in accordance with the embodiment of the present invention calculates the sustainability of a gas field development project, based on gas field factors, financial factors and organization factors.

The gas field factors are factors for the technical analysis and specification of a target gas field. If business is in an initial stage and thus there is not enough information about the gas field, the gas field factors may be acquired, based on objective information which may be obtained through analysis of extracted sample (raw feed gas (RFG)).

The financial factors are factors for participant stability. Gas field business has a characteristic that a large amount of capital is invested for a long business period, profit is not made at all for a certain period of time and a certain amount of profit is earned only after the development of a gas field is completed. Therefore, a reputable participant who can raise finances to a large scale over a long term is essential, and assessment of the participant with respect to stable support of such funding is needed.

The organization factors are factors for the stability of an enterprise. The success or failure of gas field business relies on whether it is possible to achieve an expected return within planned costs and it is necessary to assess whether an enterprise can stably plan, manage and execute the business.

Referring to FIG. 1, from such viewpoints, a system 10 for assessing sustainability of an overseas gas field development project to realize a new methodology for assessing the value of a gas field may include a gas field factor analysis section 20, a financial factor analysis section 30, an organization factor analysis section 40, and a sustainability index calculation section 50.

The gas field factor analysis section 20 calculates assessment values respectively quantified for assessment items including components of gas, expected reserves, ratio of NGL (natural gas liquid)/condensate, and infrastructure accessibility.

In detail, the assessment item of components of gas means the value of tradable product produced by RFG (raw feed gas) extracted from a gas field, and may be assessed based on the ratios of carbon compounds C1, C2, C3, C4 and C5 and expected calorific values calculated therefrom.

For example, when expected calorific value is equal to or larger than 3,400,000 MMBTU (1 million BTU), a gas field may be defined as a gas field of good quality. It is identified as a gas field of low quality if the expected calorific value is equal to or smaller than 2,700,000 MMBTU. When the expected calorific value is between the two values, it is dubbed as a regular gas field. The assessment value for the assessment item of components of gas may be given as 3 in the case of a gas field of good quality, 2 in the case of a regular gas field, and 1 in the case of a gas field of low quality.

The assessment item of expected reserves is assessed as reserves which are expected through analysis of a corresponding mining area, and is an index that is directly associated with reserve production ratio (R/P) and business continuation period. Expected reserves are analyzed by utilizing 3D seismic wave, terrain analysis, and so forth and are compared with analysis results of similar terrains and examples, and it is necessary to reflect fluctuation of analysis result.

For example, when expected reserves are equal to or larger than 5 TCF (trillion cubic feet), a gas field may be identified as a large gas field. When expected reserves are equal to or smaller than 0.5 TCF, it is called as a small gas field. When expected reserves are between the two values, it is classified as a regular gas field. The assessment value for the assessment item of expected reserves may be given as 3 in the case of a large gas field, 2 in the case of a regular gas field, and 1 in the case of a small gas field.

The assessment item of ratio of NGL/condensate is assessed as ratio of impurities and additional profitable materials and is an index that is directly associated with additional costs and additional profits in the course of developing a gas field. If a large amount of impurities is included, additional facilities and additional operation costs are required to treat the impurities. Conversely, if a large amount of components such as condensate, which may provide additional profits, is included, additional economic feasibility may be secured.

For example, when an amount of impurities such as CO2 and sulfides, which should be removed in a downstream liquefaction plant, is equal to or smaller than 15% and an amount of additional profitable materials such as condensate is large, a ratio may be defined as high. When an amount of impurities is equal to or larger 30% and an amount of additional profitable materials is small, a ratio is identified as low. When an amount of impurities and an amount of additional profitable materials are therebetween, it may be considered as regular. Accordingly, the assessment value for the assessment item of ratio of NGL/condensate may be given as 3 in the case of being high, 2 in the case of being regular, and 1 in the case of being low.

The assessment item of infrastructure accessibility is assessed as accessibility between the upstream field and the downstream field, and is an index that is directly associated with additional construction costs and additional transportation costs. If a gas field is located at a wasteland or a far ocean which is difficult to access to, construction costs and transportation costs may be additionally required.

For example, the assessment value for the assessment value of infrastructure accessibility may be given as 3 when access between the upstream field and the downstream field is technically easy, 2 when access is ordinary, and 1 when access is difficult.

The financial factor analysis section 30 calculates assessment values respectively quantified for assessment items including independent oil company (IOC) share ratio, past collaboration experience, business execution experience, and favorable investment ratio.

The assessment item of IOC share ratio is an index that is associated with the ratio of the share of IOC enterprises in the entire share. As the share ratio of enterprises which have reputability and high degree of awareness is large in the share construction of gas field business, the reliance to be secured between business participants increases. Major IOC enterprises have a large number of large oil fields and gas fields, and thus, a trust risk between participants is low. Considering that most gas field business is executed in underdeveloped countries or developing countries, participation of major IOC enterprises may be more positive than participation of local enterprises of these countries or minor enterprises.

For example, the assessment value for the assessment item of IOC share ratio may be given as 3 when the share of reputable organizations such as IOC enterprises and the government of the owner's country is equal to or larger than 70%, 1 when the share of local enterprises or minor enterprises is equal to or larger than 50%, 2 when a share is therebetween.

The assessment item of past collaboration experience is an index that is associated with reputation of past business and non-business relations between participants. Past business or non-business relations between participants, in particular, between the government of the owner's country and IOC enterprises, are important.

For example, the assessment value for the assessment item of past collaboration experience may be given as 3 when reputation between participants is determined to be relatively good, 1 when the reputation between participants is determined to be relatively bad, and 2 when there is no collaboration experience or the reputation between participants is to be determined to be regular.

The assessment item of business execution experience is an index that is associated with business competences of a leading enterprise of a gas field development project and the government of the owner's country. If the progresses and the results of other business which has been executed or is being executed by the government of the owner's country or a leading enterprise are good, it may be expected that the result of a corresponding project may be positive.

For example, the assessment value for the assessment item of business execution experience may be given as 3 when the progresses and the results of other business which has been executed or is being executed by a leading enterprise are determined to be relatively good, 1 when the progresses and the results of other business are determined to be relatively bad, and 2 when there is no business experience or the progresses and the results of other business are determined to be regular.

The assessment item of favorable investment ratio is an index that is associated with the ratio of favorable investment in the spectrum of financial investments. Gas field business requires investment over a long term and profits are generated stepwise in the future. In order to stably support such a business structure, stable support of a business investment is necessary.

For example, the assessment value for the assessment item of favorable investment ratio may be given as 3 when the ratio of favorable investment including government investment, IOC direct investment and long-term investment is higher than a first predetermined ratio, 1 when the ratio is lower than a second predetermined ratio, and 2 when the ratio is therebetween.

The organization factor analysis section 40 calculates assessment values respectively quantified for assessment items including development business execution experience, securement level of expertise, the owner's risk, and securement level of dealer.

The assessment item of development business execution experience is an index that is associated with industrial understanding of an enterprise for gas field business. A gas field has business execution structure including large scale investment and long-term business execution, and it is necessary to endure a number of risk factors and fluctuations. If such a characteristic is not understood, difficulties may be aroused from business planning stage and final business result may be affected as well.

For example, the assessment value for the assessment item of development business execution experience may be given as 3 when it is determined that development experience of a gas field and a non-gas field is substantial and results are relatively good, 1 when it is determined that results are relatively bad, and 2 when it is determined that experience is insufficient or results are regular.

The assessment item of securement level of expertise is an index that is associated with technical understanding of gas field business. Since gas field business is a sophisticated business that requires professional technologies and licenses in various engineering fields, if the professional technologies are not secured, additional expenditures or various technical problems may be aroused in the course of progressing a project. Therefore, it is necessary to assess securement level of expertise such as securement of licenses, EPC experience and operation experience.

For example, the assessment value for the assessment item of a professionalism secure level may be given as 3 when professional technologies and licenses related with a gas field are sufficiently secured, 1 when professional technologies and licenses are not secured, and 2 when professional technologies and licenses are insufficiently secured.

The assessment item of the owner's risk is an index that is associated with the reliability of the owner. Since the owner is normally the government or a national oil company (NOC) of the ordering country and generally gives guarantee for the progress of business, it is necessary to reflect the intention and the characteristic of the owner at the time of assessing the value of a gas field. If there were unreasonable cases such as construction cancellation (suspension), replacement of an enterprise, or groundless delay among the past business of the owner, it is determined that the owner's risk exists.

For example, the assessment value for the assessment item of the owner's risk may be given as 3 when there is no unreasonable past case in which the owner was involved, when unreasonable cases occurred no less than a predetermined number of times, and 2 when unreasonable cases occurred less than the predetermined number of times.

The assessment item of securement level of dealer is an index that is associated with the anticipation of stable profits. Most sales contracts for products are usually concluded before the development of a gas field is completed and those sales contracts are carried out after completion of the development of the gas field. However, since gas field business is a long-term business, it is necessary to reflect a risk of miscarriage to occur in a sales contract due to the change of buyers or variation in the situation of international market.

For example, the assessment value for the assessment item of securement level of dealer may be given as 3 when the parties of a sales contract are constituted by the government of the owner's country or the participants of business, 1 when a buyer is not secured or secured buyers are financially unstable and have low level of credit, and 2 in the other cases.

Next, the sustainability index calculation section 50 may calculate a sustainability index, based on the assessment values respectively quantified for the assessment items including components of gas, expected reserves, ratio of NGL/condensate and infrastructure accessibility, which are calculated by the gas field factor analysis section 20, the assessment values respectively quantified for the assessment items including IOC share ratio, past collaboration experience, business execution experience and favorable investment ratio, which are calculated by the financial factor analysis section 30, and the assessment values respectively quantified for the assessment items including development business execution experience, securement level of expertise, the owner's risk and securement level of dealer, which are calculated by the organization factor analysis section 40.

In detail, the sustainability index calculation section 50 may calculate the sustainability index by performing TOPSIS (technique for order of preference by similarity to ideal solution) analysis or fuzzy TOPSIS analysis, based on the assessment values respectively quantified for the assessment items including components of gas, expected reserves, ratio of NGL/condensate, infrastructure accessibility, IOC share ratio, past collaboration experience, business execution experience, favorable investment ratio, development business execution experience, securement level of expertise, the owner's risk, and securement level of dealer.

The TOPSIS analysis is a technique of selecting an alternative, which is closest to an ideal positive solution and farthest from an ideal negative solution, as the most appropriate alternative, among a plurality of alternatives.

In this case, an assessment item database may be built by the assessment results acquired from assessment by a number of professionals who assess the respective assessment items, then one optimal assessment result may be extracted by TOPSIS-analysis assessment results of the respective professionals, and the sustainability index may be calculated from the assessment values that constitute the extracted optimal assessment result.

The fuzzy TOPSIS analysis is a kind of TOPSIS analysis in the case where alternatives are expressed by fuzzy values.

Also in this case, similarly to the TOPSIS analysis, an assessment item database may be built by the assessment results acquired from assessment by a number of professionals who assess the respective assessment items, then the assessment results of the respective professionals may be converted into fuzzy assessment results, so one optimal assessment result may be extracted by fuzzy TOPSIS-analysis assessment results, and the sustainability index may be calculated from the assessment values that constitute the extracted optimal assessment result.

In further detail, the sustainability index calculation section 50 may calculate a gas field characteristic index based on the assessment items including components of gas, expected reserves, ratio of NGL/condensate and infrastructure accessibility, may calculate a participant stability index based on the assessment items including IOC share ratio, past collaboration experience, business execution experience and favorable investment ratio, and may calculate a business stability index based on the assessment items including development business execution experience, securement level of expertise, the owner's risk and securement level of dealer, among extracted optimal assessment results. Moreover, the sustainability index calculation section 50 may calculate the sustainability index based on the gas field characteristic index, the participant stability index and the business stability index that are calculated.

The sustainability index may be calculated, based on any one selected from summation, weighted summation, arithmetic averaging and weighted averaging of the gas field characteristic index, the participant stability index and the business stability index that are calculated.

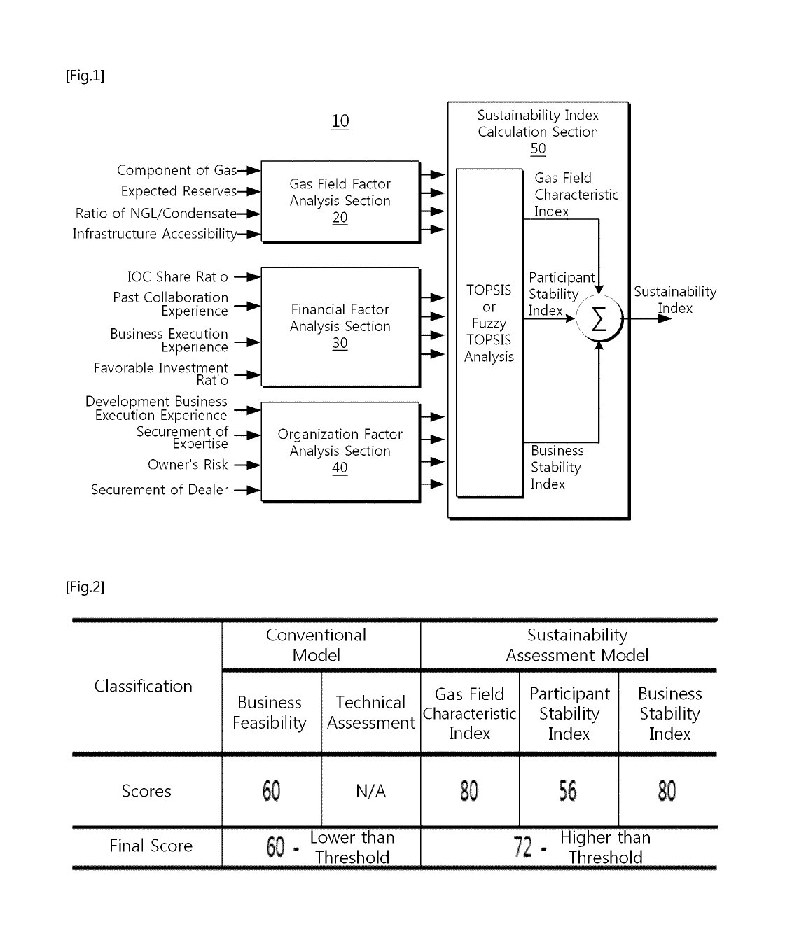

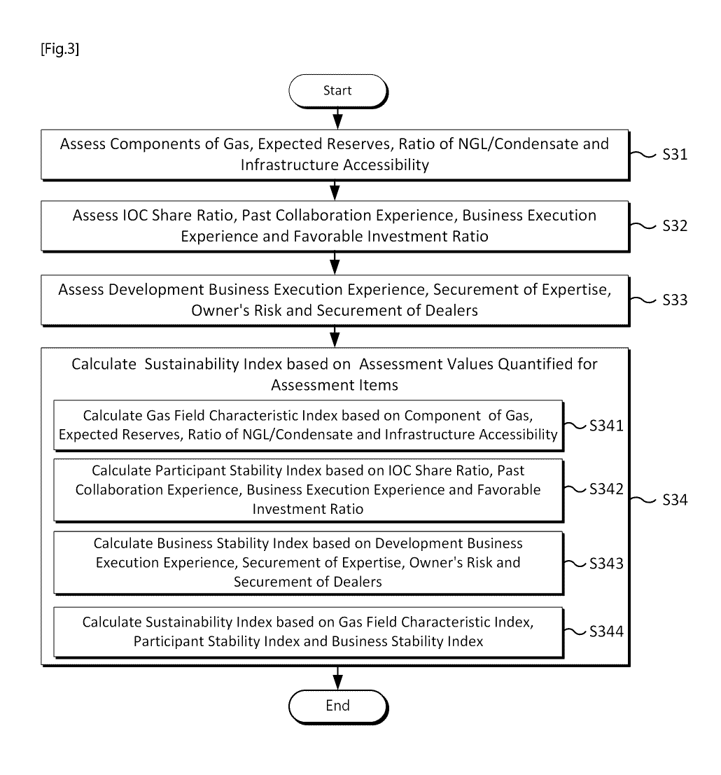

FIG. 2 is a table exemplarily showing a result of assessing an overseas gas field development project based on an actually performed example, in the system for assessing sustainability of an overseas gas field development project in accordance with the embodiment of the present invention.

Referring to FIG. 2, for an overseas gas field project of a country in Africa, which was actually performed successfully in the past, a result of assessing business feasibility by using a conventional assessment model and a result of assessing business feasibility by using the sustainability assessment model of the present invention are compared with each other. The scores were equalized as 100 points would be highest.

In the case of the conventional assessment model, higher weights were allocated to investment environment, contract conditions, financial soundness and business operation ability. Since the sovereign credit ratings of countries in Africa where gas fields are located are low, the assessment of business feasibility was calculated as 60 points, and since technical assessment model was not present, score calculation in that respect was not performed. Accordingly, a corresponding gas field was finally assessed as the low score of 60 points.

On the contrary, according to the sustainability assessment model of the present invention, the gas field characteristic index was calculated as 80 points, the participant stability index was calculated as 56 points, and the business stability index was calculated as 80 points. Finally, the sustainability index was calculated as 72 points through arithmetic averaging.

Although the participant stability index was calculated to as low due to the low sovereign credit rating of the owner, the gas field characteristic index and the business stability index were calculated to as high since reserves are large, buyers were secured, and so forth.

Therefore, according to assessment performed using the sustainability assessment model of the present invention, the corresponding gas field was assigned with the high score of 72 points.

FIG. 3 is a flow chart illustrating a method for assessing sustainability of an overseas gas field development project in accordance with an embodiment of the present invention.

In the method for assessing sustainability of an overseas gas field development project, using the sustainability assessing system of an overseas gas field development project, which includes the gas field factor analysis section 20, the financial factor analysis section 30, the organization factor analysis section 40 and the sustainability index calculation section 50, first, in step S31, the gas field factor analysis section 20 calculates assessment values respectively quantified for assessment items including components of gas, expected reserves, ratio of NGL (natural gas liquid)/condensate, and infrastructure accessibility.

The assessment item of components of gas is an assessment item that is assessed in association with the value of sellable product produced by RFG (raw feed gas) extracted from a gas field, the assessment item of expected reserves is an assessment item that is assessed in association with reserves which are expected through analysis of a corresponding mining area, the assessment item of ratio of NGL/condensate is an assessment item that is assessed in association with ratio of impurities and additional profitable materials, and the assessment item of infrastructure accessibility is an assessment item that is assessed in association with accessibility between the upstream field and the downstream field.

In step S32, the financial factor analysis section calculates assessment values respectively quantified for assessment items including IOC share ratio, past collaboration experience, business execution experience, and favorable investment ratio.

The assessment item of an IOC share ratio is an assessment item that is assessed in association with the ratio of the share of IOC enterprises in the entire share, the assessment item of past collaboration experience is an assessment item that is assessed in association with reputation of past business and non-business relations between participants, the assessment item of business execution experience is an assessment item that is assessed in association with business competences of a leading enterprise of a gas field development project and the government of the owner, and the assessment item of favorable investment ratio is an assessment item that is assessed in association with the ratio of favorable investment in the spectrum of financial investments.

In step S33, the organization factor analysis section 40 calculates assessment values respectively quantified for assessment items including development business execution experience, securement level of expertise, the owner's risk, and securement level of dealer.

The assessment item of development business execution experience is an assessment item that is assessed in association with industrial understanding of an enterprise for gas field business, the assessment item of securement level of expertise is an assessment item that is assessed in association with technical understanding of gas field business, the assessment item of the owner's risk is an assessment item that is assessed in association with the reliability of the owner, and the assessment item of securement level of dealer is an assessment item that is assessed in association with the anticipation of stable profits.

In step S34, the sustainability index calculation section 50 may calculate the sustainability index based on the assessment values respectively quantified for the assessment items including components of gas, expected reserves, ratio of NGL/condensate, infrastructure accessibility, IOC share ratio, past collaboration experience, business execution experience, favorable investment ratio, development business execution experience, securement level of expertise, the owner's risk, and securement level of dealer.

In detail, the sustainability index may be calculated by performing TOPSIS analysis or fuzzy TOPSIS analysis, based on the assessment values respectively quantified for the assessment items including components of gas, expected reserves, ratio of NGL/condensate, infrastructure accessibility, IOC share ratio, past collaboration experience, business execution experience, favorable investment ratio, development business execution experience, securement level of expertise, the owner's risk, and securement level of dealer.

In an embodiment, the sustainability index may be calculated from assessment values that constitute an optimal assessment result, the optimal assessment result being extracted through TOPSIS analysis of assessment results obtained by professionals who assess the respective assessment items.

In another embodiment, the sustainability index may be calculated from assessment values that constitute an optimal assessment result, the optimal assessment result being extracted through fuzzy TOPSIS analysis of fuzzy assessment results which are converted from assessment results obtained by professionals who assess the respective assessment items.

In further detail, in the step S34, the sustainability index calculation section 50 may calculate a gas field characteristic index based on the assessment items including components of gas, expected reserves, ratio of NGL/condensate and infrastructure accessibility (S341), may calculate a participant stability index based on the assessment items including IOC share ratio, past collaboration experience, business execution experience and favorable investment ratio (S342), may calculate a business stability index based on the assessment items including development business execution experience, securement level of expertise, the owner's risk and securement level of dealer (S343), among extracted optimal assessment results, and may calculate the sustainability index based on the gas field characteristic index, the participant stability index and the business stability index that are calculated (S344).

According to an embodiment, the sustainability index may be calculated, based on any one selected from summation, weighted summation, arithmetic averaging and weighted averaging of the gas field characteristic index, the participant stability index and the business stability index that are calculated.

The exemplary embodiments of the present invention and the drawings included in the present specification are to clearly describe some of technical ideas included in the present invention, and it is apparent that the modifications and the detailed exemplary embodiments easily derived by those skilled in the art without departing from the technical spirit included in the specification and drawings of the present invention fall under the scope of protection in the present invention.

The apparatus in accordance with the embodiment of the present invention may be realized by computer-readable codes in a computer-readable recording medium. The computer-readable recording medium includes all kinds of recording devices in which data that may be read by a computer system are stored. Examples of the recording medium includes a ROM, a RAM, an optical disk, a magnetic tape, a floppy disk, a hard disk, a nonvolatile memory, and so forth. In addition, the computer-readable recording medium may be distributed in computer systems which are connected through a network, such that codes that may be read in a distributed scheme by computers may be stored and executed in the computer readable recording medium.

What is claimed is:

1. A system for assessing sustainability of an overseas gas field development project, comprising:
a gas field factor analysis section configured to calculate assessment values respectively quantified for assessment items including components of gas, expected reserves, ratio of NGL (natural gas liquid)/condensate, and infrastructure accessibility;
a financial factor analysis section configured to calculate assessment values respectively quantified for assessment items including independent oil company (IOC) share ratio, past collaboration experience, business execution experience, and favorable investment ratio;
an organization factor analysis section configured to calculate assessment values respectively quantified for assessment items including development business execution experience, securement level of expertise, the owner's risk, and securement level of dealer; and
a sustainability index calculation section configured to calculate a sustainability index, based on the assessment values for the assessment items including components of gas, expected reserves, ratio of NGL/condensate and infrastructure accessibility, which are calculated by the gas field factor analysis section, the assessment values for the assessment items including IOC share ratio, past collaboration experience, business execution experience and favorable investment ratio, which are calculated by the financial factor analysis section, and the assessment values for the assessment items including development business execution experience, securement level of expertise, the owner's risk and securement level of dealer, which are calculated by the organization factor analysis section.

2. The system according to claim 1, wherein the assessment item of components of gas is an assessment item that is assessed in association with value of product produced by RFG (raw feed gas) extracted from a gas field, the assessment item of expected reserves is an assessment item that is assessed in association with reserves which are expected through analysis of a corresponding mining area, the assessment item of ratio of NGL/condensate is an assessment item that is assessed in association with ratio of impurities and additional profitable materials, and the assessment item of infrastructure accessibility is an assessment item that is assessed in association with accessibility between upstream field and downstream field.

3. The system according to claim 1, wherein the assessment item of an IOC share ratio is an assessment item that is assessed in association with ratio of share of IOC enterprises in entire share, the assessment item of past collaboration experience is an assessment item that is assessed in association with reputation of past business and non-business relations between participants, the assessment item of business execution experience is an assessment item that is assessed in association with business competences of a leading enterprise of a gas field development project and a government of the owner, and the assessment item of favorable investment ratio is an assessment item that is assessed in association with ratio of favorable investment in spectrum of financial investments.

4. The system according to claim 1, wherein the assessment item of development business execution experience is an assessment item that is assessed in association with industrial understanding of an enterprise for gas field business, the assessment item of securement level of expertise is an assessment item that is assessed in association with technical understanding of gas field business, the assessment item of the owner's risk is an assessment item that is assessed in association with reliability of the owner, and the assessment item of securement level of dealer is an assessment item that is assessed in association with anticipation of stable profits.

5. The system according to claim 1, wherein the sustainability index is calculated by performing TOPSIS (technique for order of preference by similarity to ideal solution) analysis or fuzzy TOPSIS analysis, based on the assessment values respectively quantified for the assessment items including components of gas, expected reserves, ratio of NGL/condensate, infrastructure accessibility, IOC share ratio, past collaboration experience, business execution experience, favorable investment ratio, development business execution experience, securement level of expertise, the owner's risk, and securement level of dealer.

6. The system according to claim 1, wherein, the sustainability index is calculated from assessment values that constitute an optimal assessment result, the optimal assessment result being extracted through TOPSIS analysis of assessment results obtained by professionals who assess the respective assessment items.

7. The system according to claim 1, wherein, the sustainability index is calculated from assessment values that constitute an optimal assessment result, the optimal assessment result being extracted through fuzzy TOPSIS analysis of fuzzy assessment results which are converted from assessment results obtained by professionals who assess the respective assessment items.

8. The system according to claim 1, wherein the sustainability index calculation section operates to calculate a gas field characteristic index based on the assessment items including components of gas, expected reserves, ratio of NGL/condensate and infrastructure accessibility, calculate a participant stability index based on the assessment items including IOC share ratio, past collaboration experience, business execution experience and favorable investment ratio, calculate a business stability index based on the assessment items including development business execution experience, securement level of expertise, the owner's risk and securement level of dealer, among extracted optimal assessment results, and calculate the sustainability index based on the gas field characteristic index, the participant stability index and the business stability index that are calculated.

9. The system according to claim 8, wherein the sustainability index is calculated, based on any one selected from summation, weighted summation, arithmetic averaging and weighted averaging of the gas field characteristic index, the participant stability index and the business stability index that are calculated.

10. A recording medium configured to be read by a computer recorded with a computer program which is realized to operate the computer as the system for assessing sustainability of an overseas gas field development project according to any one of claims 1 to 9.

11. A method for assessing sustainability of an overseas gas field development project, using a system for assessing sustainability of an overseas gas field development project, which includes a gas field factor analysis section, a financial factor analysis section, an organization factor analysis section and a sustainability index calculation section, the method comprising:
calculating, by the gas field factor analysis section, assessment values respectively quantified for assessment items including components of gas, expected reserves, ratio of NGL/condensate, and infrastructure accessibility;
calculating, by the financial factor analysis section, assessment values respectively quantified for assessment items including IOC share ratio, past collaboration experience, business execution experience, and favorable investment ratio;
calculating, by the organization factor analysis section, assessment values respectively quantified for assessment items including development business execution experience, securement level of expertise, the owner's risk, and securement level of dealer; and
calculating, by the sustainability index calculation section, a sustainability index, based on the assessment values for the assessment items including components of gas, expected reserves, ratio of NGL/condensate and infrastructure accessibility, which are calculated by the gas field factor analysis section, the assessment values for the assessment items including IOC share ratio, past collaboration experience, business execution experience and favorable investment ratio, which are calculated by the financial factor analysis section, and the assessment values for the assessment items including development business execution experience, securement level of expertise, the owner's risk and securement level of dealer, which are calculated by the organization factor analysis section.

12. The method according to claim 11, wherein the assessment item of components of gas is an assessment item that is assessed in association with value of product produced by RFG (raw feed gas) extracted from a gas field, the assessment item of expected reserves is an assessment item that is assessed in association with reserves which are expected through analysis of a corresponding mining area, the assessment item of ratio of NGL/condensate is an assessment item that is assessed in association with ratio of impurities and additional profitable materials, and the assessment item of infrastructure accessibility is an assessment item that is assessed in association with accessibility between upstream field and downstream field.

13. The method according to claim 11, wherein the assessment item of IOC share ratio is an assessment item that is assessed in association with ratio of share of IOC enterprises in entire share, the assessment item of past collaboration experience is an assessment item that is assessed in association with reputation of past business and non-business relations between participants, the assessment item of business execution experience is an assessment item that is assessed in association with business competences of a leading enterprise of a gas field development project and a government of the owner, and the assessment item of favorable investment ratio is an assessment item that is assessed in association with ratio of favorable investment in spectrum of financial investments.

14. The method according to claim 11, wherein the assessment item of development business execution experience is an assessment item that is assessed in association with industrial understanding of an enterprise for gas field business, the assessment item of securement level of expertise is an assessment item that is assessed in association with technical understanding of gas field business, the assessment item of the owner's risk is an assessment item that is assessed in association with reliability of the owner, and the assessment item of securement level of dealer is an assessment item that is assessed in association with anticipation of stable profits.

15. The method according to claim 11, wherein the sustainability index is calculated by performing TOPSIS (technique for order of preference by similarity to ideal solution) analysis or fuzzy TOPSIS analysis, based on the assessment values respectively quantified for the assessment items including components of gas, expected reserves, ratio of NGL/condensate, infrastructure accessibility, IOC share ratio, past collaboration experience, business execution experience, favorable investment ratio, development business execution experience, securement level of expertise, the owner's risk, and securement level of dealer.

16. The method according to claim 11, wherein, the sustainability index may be calculated from assessment values that constitute an optimal assessment result, the optimal assessment result being extracted through TOPSIS analysis of assessment results obtained by professionals who assess the respective assessment items.

17. The method according to claim 11, wherein, the sustainability index may be calculated from assessment values that constitute an optimal assessment result, the optimal assessment result being extracted through fuzzy TOPSIS analysis of fuzzy assessment results which are converted from assessment results obtained by professionals who assess the respective assessment items.

18. The method according to claim 11, wherein the calculating of the sustainability index comprises:
calculating a gas field characteristic index based on the assessment items including components of gas, expected reserves, ratio of NGL/condensate and infrastructure accessibility;
calculating a participant stability index based on the assessment items including IOC share ratio, past collaboration experience, business execution experience and favorable investment ratio;
calculating a business stability index based on the assessment items including development business execution experience, securement level of expertise, the owner's risk and securement level of dealer, among extracted optimal assessment results; and
calculating the sustainability index based on the gas field characteristic index, the participant stability index and the business stability index that are calculated.

19. The method according to claim 18, wherein the sustainability index is calculated, based on any one selected from summation, weighted summation, arithmetic averaging and weighted averaging of the gas field characteristic index, the participant stability index and the business stability index, that are calculated.

20. A recording medium configured to be read by a computer recorded with a computer program which realizes the method for assessing sustainability of an overseas gas field development project according to any one of claims 11 to 19, in the computer.
